(19) United States
(12) Patent Application Publication
(10) Pub. No.: US 2025/0251108 A1
(43) Pub. Date: Aug. 7, 2025

(54) ILLUMINATION SYSTEM

(71) Applicant: QISDA CORPORATION, Taoyuan City (TW)

(72) Inventors: Chao-Shun Yu, Taoyuan City (TW); Wen-Chang Chen, Taoyuan City (TW); Chun-Sheng Hu, Taichung City (TW)

(73) Assignee: QISDA CORPORATION, Taoyuan City (TW)

(21) Appl. No.: 19/010,150

(22) Filed: Jan. 5, 2025

(30) Foreign Application Priority Data
Feb. 5, 2024 (TW) 113104342

(51) Int. Cl. F21S 41/675; F21S 41/141

(52) U.S. Cl. CPC F21S 41/675; F21S 41/141

(57) ABSTRACT

An illumination system includes a first light source, a second light source and an operation processor. The first light source provides a first illumination range. The second light source provides a second illumination range partly overlapped with the first illumination range. The operation processor is electrically connected to the first light source and the second light source. The operation processor can adjust a first lighting parameter of the first light source to be different from a second lighting parameter of the second light source, so as to reduce or eliminate a flicker phenomenon in an overlapping illumination range between the first illumination range and the second illumination range.

### BACKGROUND OF THE INVENTION

### 1. Field of the Invention

The present invention relates to an illumination system, and more particularly, to an illumination system capable of reducing or eliminating the flicker phenomenon.

### 2. Description of the Prior Art

With the advanced technology, an adaptive vehicle lighting system is widely applied to new cars. The adaptive vehicle lighting system includes the light source array, the detection device and the control device. The light source array has the zoned light units that are independently adjustable. The detection device detects the oncoming vehicles or the oncoming humans in front of the vehicle where on the adaptive vehicle lighting system is installed. The control device adjusts the zoned light units of the light source array in accordance with the detection result of the detection device, so as to provide adaptive conversion of the high beam type, which illuminates the forward vision of the vehicle and protects the driver of the oncoming vehicles. However, the conventional adaptive vehicle lighting system switches the zoned light units of the light source array in accordance with the detection result of the oncoming vehicles or the oncoming humans, and the high frequency switching operation results in the flicker phenomenon. The flicker phenomenon may cause headaches and visual fatigue of the vehicle's drivers, and also distract the attention of the vehicle's drivers, and even cause the photosensitive epilepsy. Therefore, design of an illumination system of eliminating the flicker phenomenon for driving safety is an important issue in the related industry.

### SUMMARY OF THE INVENTION

The present invention provides an illumination system capable of reducing or eliminating the flicker phenomenon for solving above drawbacks.

According to the claimed invention, an illumination system includes a first light source, a second light source and an operation processor. The first light source is adapted to provide a first illumination range. The second light source is adapted to provide a second illumination range partly overlapped with the first illumination range. The operation processor is electrically connected to the first light source and the second light source, and adapted to adjust a first lighting parameter of the first light source for being different from a second lighting parameter of the second light source, so as to reduce or eliminate a flicker phenomenon in an overlapping illumination range between the first illumination range and the second illumination range.

According to the claimed invention, the first lighting parameter is a first scanning frequency of the first light source, the second lighting parameter is a second scanning frequency of the second light source, and the first scanning frequency and the second scanning frequency are in a multiple relationship.

According to the claimed invention, the first lighting parameter is a first scanning frequency of the first light source, the second lighting parameter is a second scanning frequency of the second light source, and clock speeds of the first scanning frequency and the second scanning frequency are varied randomly.

According to the claimed invention, the first lighting parameter is a first scanning frequency of the first light source, the second lighting parameter is a second scanning frequency of the second light source, the first scanning frequency is synchronized with the second scanning frequency, and the first scanning frequency and the second scanning frequency has phase difference with a feature of light and dark complementary.

According to the claimed invention, the phase difference between the first scanning frequency and the second scanning frequency is one hundred and eighty degrees, or the phase difference is one hundred and eighty degrees with an allowable error of ten percent. A duration of a high level area of at least one of the first scanning frequency and the second scanning frequency is greater than a duration of a low level area of the at least one of the first scanning frequency and the second scanning frequency.

According to the claimed invention, the first lighting parameter is a first scanning frequency of the first light source, the second lighting parameter is a second scanning frequency of the second light source, the first scanning frequency is different from the second scanning frequency, and the first scanning frequency and the second scanning frequency has phase difference with a feature of light and dark complementary.

According to the claimed invention, the first lighting parameter is a first scanning frequency of the first light source, the second lighting parameter is a second scanning frequency of the second light source, and a first scanning direction of the first scanning frequency is different from a second scanning direction of the second scanning frequency. The first scanning direction is opposite to the second scanning direction.

According to the claimed invention, the first light source and the second light source respectively are a light emitting diode, the illumination system further includes a micro-reflector adapted to reflect illumination light emitted by the foresaid light emitting diodes for adjusting the first lighting parameter and the second lighting parameter and further providing the first illumination range and the second illumination range.

According to the claimed invention, the first light source and the second light source respectively are a LED module, and the LED module includes a plurality of light emitting diode units arranged as an array. Further, the first light source and the second light source respectively are a laser unit, the illumination system further includes a micro-reflector adapted to reflect illumination light emitted by the foresaid laser units for adjusting the first lighting parameter and the second lighting parameter and further providing the first illumination range and the second illumination range.

According to the claimed invention, the illumination system further includes an optical detector electrically connected to the operation processor, the operation processor is adapted to analyze an environment detection result of the optical detector for adjusting the first lighting parameter and/or the second lighting parameter. The illumination system is applied to a headlight.

The illumination system of the present invention can include the first light source and the second light source that have the overlapped illumination range. The first lighting parameter of the first light source and the second lighting parameter of the second light source may have differences in frequency and/or phase. An ideal state of the illumination system can allow the bright area provided by the first light source during the scanning process to correspond to or cover the dark area generated by the second light source during the scanning process, so that the overlapping illumination range of the illumination system does not have the flicker phenomenon because of misalignment of the bright area and the dark area of two light sources; it means that the first scanning frequency and the second scanning frequency can be in the multiple relationship, or the clock speeds of the first scanning frequency and the second scanning frequency can be varied randomly, or the first scanning frequency and the second scanning frequency can have the phase difference with the feature of light and dark complementary, or the first scanning frequency and the second scanning frequency can have the allowable error and/or difference in the voltage levels, or the first scanning frequency and the second scanning frequency can have different scanning directions.

When the first scanning frequency is synchronized with the second scanning frequency, the first light source and the second light source may have the same frequency and different phases with the specific phase difference; a width of the high voltage level of the scanning frequency may be different from a width of the low voltage level of the scanning frequency for intensity compensation. The illumination system of the present invention can provide various types of embodiments, and can adjust the phase difference to reduce or eliminate the flicker phenomenon when the frequency of the first light source and the second light source are synchronized; the illumination system of the present invention further can include the first light source and the second light source with different scanning frequencies, and the scanning frequencies of two light sources can be in the multiple relationship or varied randomly for reducing or eliminating the flicker phenomenon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an illumination system according to an embodiment of the present invention.

FIG. 2 is an application diagram of the illumination system according to the embodiment of the present invention.

FIG. 3 is a diagram of a first light source and a second light source according to a first embodiment of the present invention.

FIG. 4 is a diagram of the first light source and the second light source according to a second embodiment of the present invention.

FIG. 5 is a diagram of the first light source and the second light source according to a third embodiment of the present invention.

FIG. 6 to FIG. 9 are variation diagrams of the lighting parameter of the illumination system according to different embodiments of the present invention.

FIG. 10 and FIG. 11 are diagrams of the illumination system according to different embodiments of the present invention.

### DETAILED DESCRIPTION

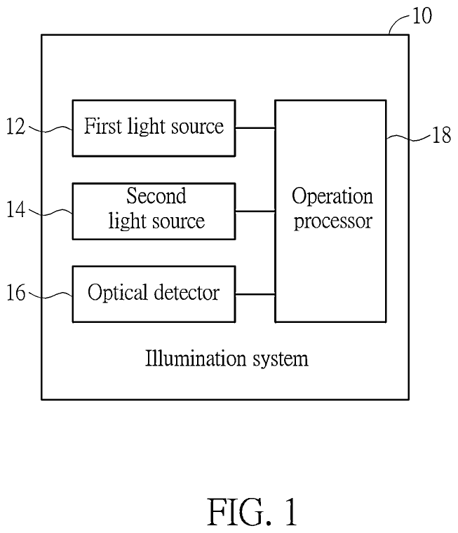

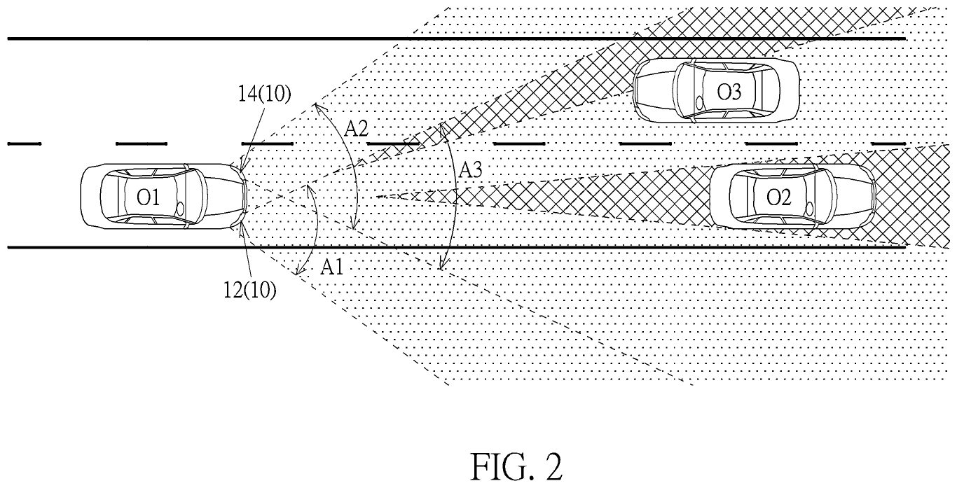

Please refer to FIG. 1 and FIG. 2. FIG. 1 is a functional block diagram of an illumination system 10 according to an embodiment of the present invention. FIG. 2 is an application diagram of the illumination system 10 according to the embodiment of the present invention. The illumination system 10 can be an illumination system capable of automatically adjust illumination light, and used to ensure a bright field of view within an illumination range and prevent humans inside the illumination range from being affected by glare. The illumination system 10 can adaptively adjust lighting parameters of several light sources to effectively reduce or eliminate a flicker phenomenon within the illumination range. Generally, the illumination system 10 can be applied for a headlight, and a practical application of the illumination system 10 is not limited to the foresaid embodiment. The illumination system 10 of the present invention can adjust a bright area and a dark area of the illumination range to avoid the glare in danger according to cars or humans in front of the vehicle where on the illumination system 10 is installed, and further can adjust the lighting parameters of the left headlight and the right headlight to reduce or eliminate the flicker phenomenon.

It should be mentioned that the illumination system 10 adjusting the bright area within the illumination range can be interpreted as turning on a high beam mode at a certain area (such as the dotted area shown in FIG. 2) within the illumination range, or increasing an illumination intensity of the foresaid certain area; the illumination system 10 adjusting the dark area within the illumination range can be interpreted as switching into a low beam mode from the high beam mode at the certain area (such as the checkered area shown in FIG. 2), or decreasing the illumination intensity of the foresaid certain area. However, actual application of adjusting the bright area and the dark area is not limited to the above-mentioned embodiments, and a detailed description is omitted herein for simplicity.

The illumination system 10 can include a first light source 12, a second light source 14, an optical detector 16 and an operation processor 18. The first light source 12 and the second light source 14 can respectively provide a first illumination range A1 and a second illumination range A2, and the first illumination range A1 can be partly overlapped with the second illumination range A2 to form an overlapping illumination range A3. The operation processor 18 can be electrically connected to the first light source 12, the second light source 14 and the optical detector 16. The illumination system 10 can be installed on the vehicle O1. The operation processor 18 can analyze an environment detection result of the optical detector 16, such as the oncoming vehicles O2 and O3, and accordingly adjust a first lighting parameter of the first light source 12 for being different from a second lighting parameter of the second light source 14, so as to reduce or eliminate the flicker phenomenon of the overlapping illumination range A3 between the first illumination range A1 and the second illumination range A2.

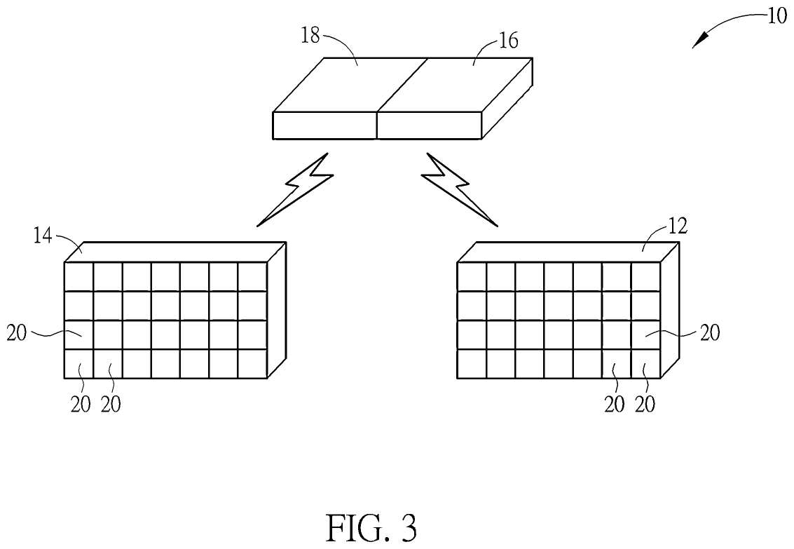

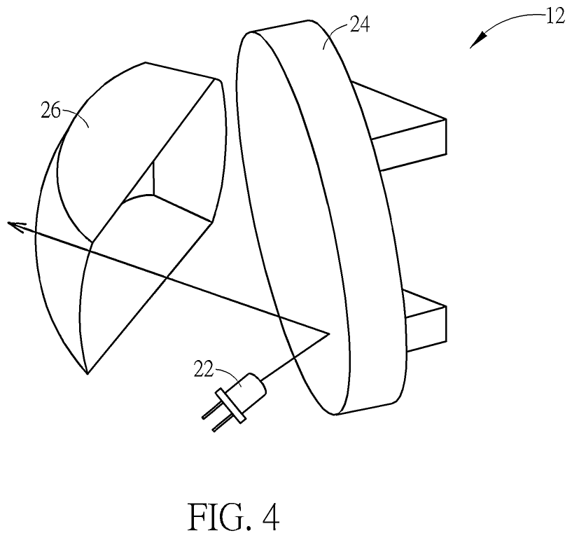

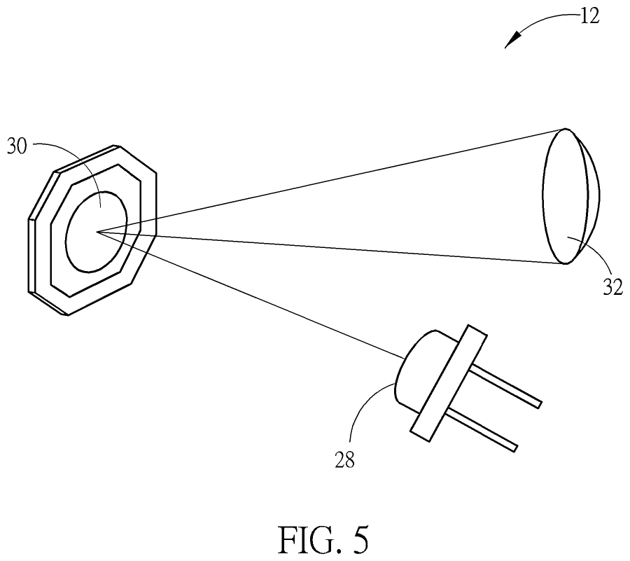

The first light source 12 and the second light source 14 can be various types of light source devices. Please refer to FIG. 3 to FIG. 5. FIG. 3 is a diagram of the first light source 12 and the second light source 14 according to a first embodiment of the present invention. FIG. 4 is a diagram of the first light source 12 and the second light source 14 according to a second embodiment of the present invention. FIG. 5 is a diagram of the first light source 12 and the second light source 14 according to a third embodiment of the present invention. As the first embodiment shown in FIG. 3, the first light source 12 and the second light source 14 can respectively be a LED (light emitting diode) module, and each LED module can include a plurality of light emitting diode units 20 arranged as an array. The operation processor 18 can optionally control one or some light emitting diode units 20 of the first light source 12 and/or the second light source 14 to reduce or eliminate the flicker phenomenon of the overlapping illumination range A3.

As the second embodiment shown in FIG. 4, any of the first light source 12 and the second light source 14 can be designed as a light emitting diode 22, and the illumination system 10 can further include a micro-reflector 24 (or a micro-mirror) disposed adjacent to the light emitting diode 22. The illumination light emitted by the light emitting diode 22 can be reflected by the micro-reflector 24 for adjusting the first lighting parameter (or the second lighting parameter) and providing towards the first illumination range A1 (or the second illumination range A2). In the second embodiment, a lens 26 can be optionally disposed adjacent to the micro-reflector 24 of the first light source 12 (or the second light source 14) and used to control convergence of the illumination light. The operation processor 18 can control the micro-reflector 24 to adjust the lighting parameter of the first light source 12 and/or the second light source 14, so as to reduce or eliminate the flicker phenomenon of the overlapping illumination range A3.

As the third embodiment of FIG. 5, any of the first light source 12 and the second light source 14 can be designed as a laser unit 28, and the illumination system 10 can further include a micro-reflector 30 (or the micro-mirror) disposed adjacent to the laser unit 28. The illumination light emitted by the laser unit 28 can be reflected by the micro-reflector 30 for adjusting the first lighting parameter (or the second lighting parameter) and providing towards the first illumination range A1 (or the second illumination range A2). In the third embodiment, a lens 32 can be optionally disposed adjacent to the micro-reflector 30 of the first light source 12 (or the second light source 14) and used to control convergence of the illumination light, as a function of the lens 26. The operation processor 18 can control the micro-reflector 30 to adjust the lighting parameter of the first light source 12 and/or the second light source 14, so as to reduce or eliminate the flicker phenomenon of the overlapping illumination range A3.

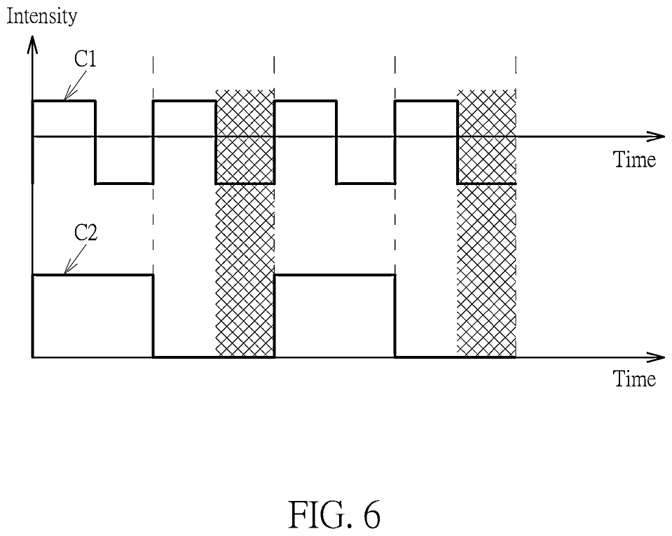

Please refer to FIG. 6 to FIG. 9. FIG. 6 to FIG. 9 are variation diagrams of the lighting parameter of the illumination system 10 according to different embodiments of the present invention. The lighting parameter can be frequency change or phase change of the first light source 12 and the second light source 14, and may be applied in various types of changes in different embodiments. As the embodiment shown in FIG. 6, the first lighting parameter can be a first scanning frequency of the first light source 12, and the frequency change of the first scanning frequency can be indicated as a square wave C1; the second lighting parameter can be a second scanning frequency of the second light source 14, and the frequency change of the second scanning frequency can be indicated as a square wave C2. In this embodiment, the first scanning frequency C1 can be different from the second scanning frequency C2; the first scanning frequency Cl and the second scanning frequency C2 can be in a multiple relationship and have phase difference with a feature of light and dark complementary, which means a dark area (such as a low level area drawn with a diagonal area in FIG. 6) of an imaging result provided by the first light source 12 and the second light source 14 can be appeared as least common multiple of the first scanning frequency C1 and the second scanning frequency C2.

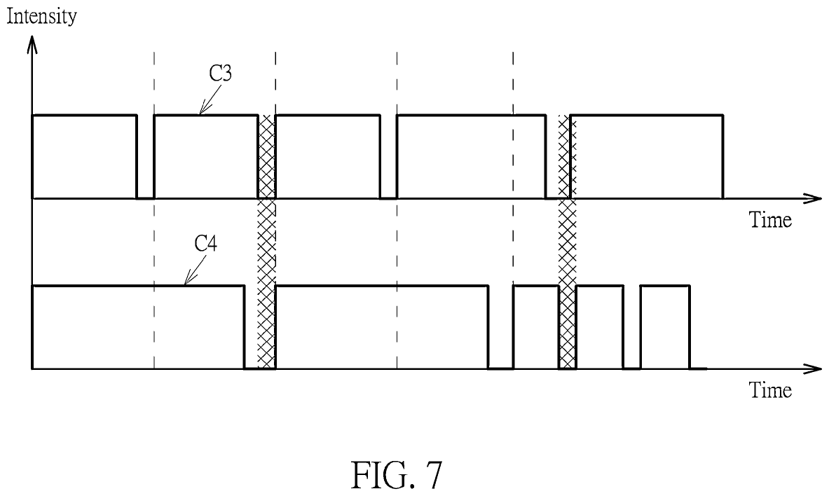

As the embodiment shown in FIG. 7, the first lighting parameter can be the first scanning frequency of the first light source 12, and the frequency change of the first scanning frequency can be indicated as a square wave C3; the second lighting parameter can be the second scanning frequency of the second light source 14, and the frequency change of the second scanning frequency can be indicated as a square wave C4. In this embodiment, clock speeds of the first scanning frequency C3 and the second scanning frequency C4 can be varied randomly, so that the dark area (such as the low level area drawn with the diagonal area in FIG. 7) of the imaging result provided by the first light source 12 and the second light source 14 can be appeared randomly.

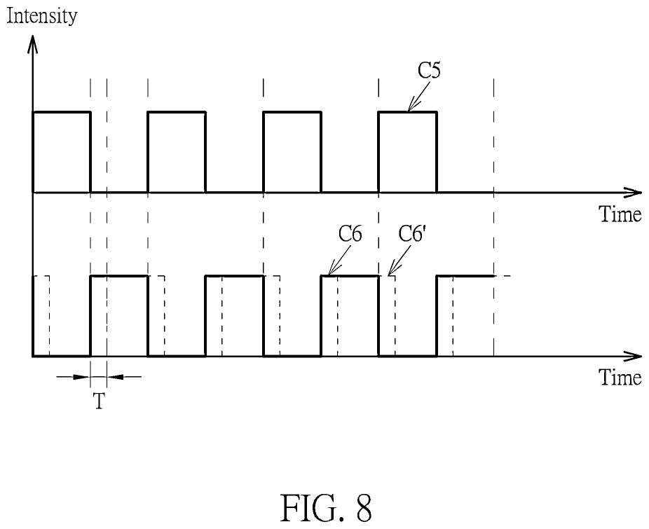

As the embodiment shown in FIG. 8, the first lighting parameter can be the first scanning frequency of the first light source 12, and the frequency change of the first scanning frequency can be indicated as a square wave C5; the second lighting parameter can be the second scanning frequency of the second light source 14, and the frequency change of the second scanning frequency can be indicated as a square wave C6. In this embodiment, the first scanning frequency C5 can be synchronized with the second scanning frequency C6; the first scanning frequency C5 and the second scanning frequency C6 can have the phase difference with the feature of light and dark complementary, which means a bright area (such as a high level area of the first scanning frequency C5 in FIG. 8) of the first light source 12 can cover the dark area (such as the low level area of the second scanning frequency C6 in FIG. 8) of the second light source 14. The phase difference between the first scanning frequency C5 and the second scanning frequency C6 can be one hundred and eighty degrees; however, practical application of the phase difference is not limited to the foresaid embodiment. For example, the phase difference can be one hundred and eighty degrees with an allowable error T of ten percent, such as the first scanning frequency C5 and the adjusted second scanning frequency C6′.

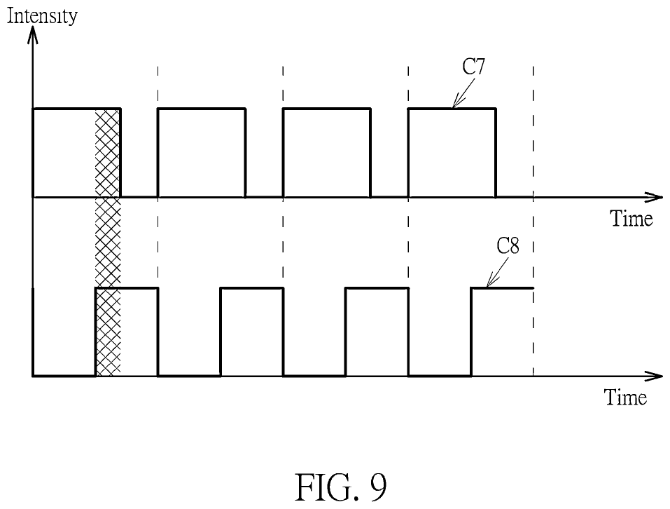

Further, the embodiment shown in FIG. 8 may utilize design of specific voltage level correction to overcome the allowable error T. As the embodiment shown in FIG. 9, the first lighting parameter can be the first scanning frequency of the first light source 12, and the frequency change of the first scanning frequency can be indicated as a square wave C7; the second lighting parameter can be the second scanning frequency of the second light source 14, and the frequency change of the second scanning frequency can be indicated as a square wave C8. In this embodiment, the first scanning frequency C7 can be synchronized with the second scanning frequency C8; the first scanning frequency C7 and the second scanning frequency C8 can have the phase difference with the feature of light and dark complementary. Besides, a duration of the high level area of the first scanning frequency C7 can be greater than a duration of the low level area of the first scanning frequency C7, so that compensation of the bright area (which means the high level area is greater than the low level area) of the first scanning frequency C7 can cover the dark area of the imaging result generated due to the allowable error T and provided by the first light source 12 and the second light source 14 even though there is the allowable error T existed between the first scanning frequency C7 and the second scanning frequency C8.

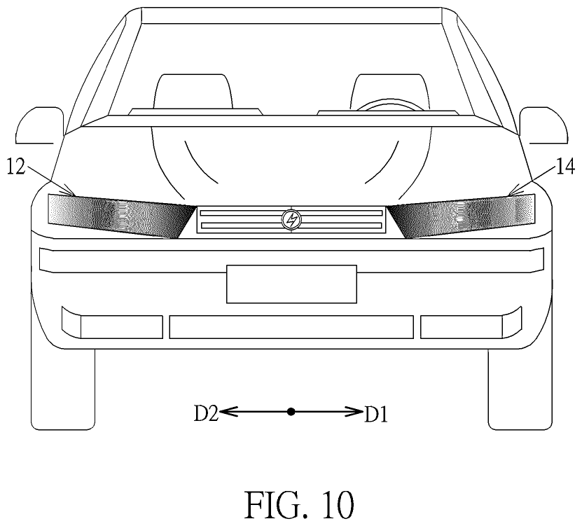

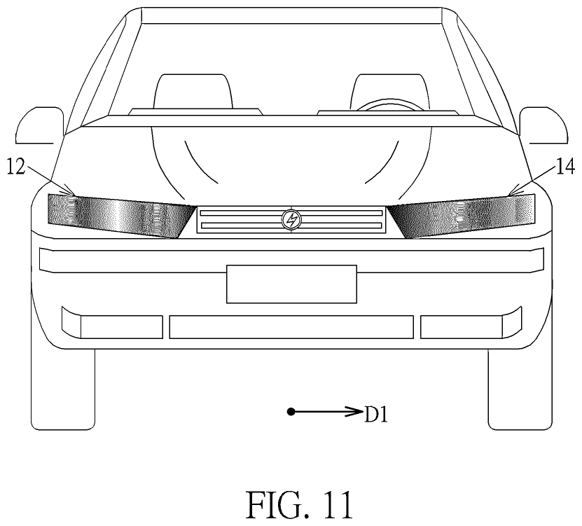

Please refer to FIG. 10 and FIG. 11. FIG. 10 and FIG. 11 are diagrams of the illumination system 10 according to different embodiments of the present invention. As the embodiment shown in FIG. 10, the first lighting parameter can be the first scanning frequency of the first light source 12, and the second lighting parameter can be the second scanning frequency of the second light source 14, and a first scanning direction DI of the first light source 12 can be opposite to a second scanning direction D2 of the second light source 14. For example, each lighting unit of the lighting unit array of the first light source 12 can be sequentially turned on in the first scanning direction D1, and can be automatically turned off after being turned on for a period of time (such as a few seconds); each lighting unit of the lighting unit array of the second light source 14 can be sequentially turned on in the second scanning direction D2, and can be automatically turned off after being turned on for another period of time (such as a few seconds). In this embodiment, the first light source 12 and the second light source 14 can respectively belong to a single emission source, such as a laser unit, and can respectively scan in the first scanning direction DI and the second scanning direction D2 via the same frequency and the same phase.

As the embodiment shown in FIG. 11, the first scanning direction D1 of the first light source 12 can be the same as the second scanning direction D2 of the second light source 14, and the first scanning frequency and the second scanning frequency can have the phase difference with the feature of light and dark complementary, which means a scanning speed of the lighting unit array of the first light source 12 can quicker than or smaller than a scanning speed of the lighting unit array of the second light source 14. The first light source 12 and the second light source 14 that are as applied by the lighting unit array or the single emission source such as the laser unit can belong to a design scope of the illumination system 10 of the present invention.

In conclusion, the illumination system of the present invention can include the first light source and the second light source that have the overlapped illumination range. The first lighting parameter of the first light source and the second lighting parameter of the second light source may have differences in frequency and/or phase. An ideal state of the illumination system can allow the bright area provided by the first light source during the scanning process to correspond to or cover the dark area generated by the second light source during the scanning process, so that the overlapping illumination range of the illumination system does not have the flicker phenomenon because of misalignment of the bright area and the dark area of two light sources; it means that the first scanning frequency and the second scanning frequency can be in the multiple relationship, or the clock speeds of the first scanning frequency and the second scanning frequency can be varied randomly, or the first scanning frequency and the second scanning frequency can have the phase difference with the feature of light and dark complementary, or the first scanning frequency and the second scanning frequency can have the allowable error and/or difference in the voltage levels, or the first scanning frequency and the second scanning frequency can have different scanning directions.

When the first scanning frequency is synchronized with the second scanning frequency, the first light source and the second light source may have the same frequency and different phases with the specific phase difference; a width of the high voltage level of the scanning frequency may be different from a width of the low voltage level of the scanning frequency for intensity compensation. The illumination system of the present invention can provide various types of embodiments, and can adjust the phase difference to reduce or eliminate the flicker phenomenon when the frequency of the first light source and the second light source are synchronized; the illumination system of the present invention further can include the first light source and the second light source with different scanning frequencies, and the scanning frequencies of two light sources can be in the multiple relationship or varied randomly for reducing or eliminating the flicker phenomenon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination system comprising:
a first light source adapted to provide a first illumination range;
a second light source adapted to provide a second illumination range partly overlapped with the first illumination range; and
an operation processor electrically connected to the first light source and the second light source, and adapted to adjust a first lighting parameter of the first light source for being different from a second lighting parameter of the second light source, so as to reduce or eliminate a flicker phenomenon in an overlapping illumination range between the first illumination range and the second illumination range.

2. The illumination system of claim 1, wherein the first lighting parameter is a first scanning frequency of the first light source, the second lighting parameter is a second scanning frequency of the second light source, and the first scanning frequency and the second scanning frequency are in a multiple relationship.

3. The illumination system of claim 1, wherein the first lighting parameter is a first scanning frequency of the first light source, the second lighting parameter is a second scanning frequency of the second light source, and clock speeds of the first scanning frequency and the second scanning frequency are varied randomly.

4. The illumination system of claim 1, wherein the first lighting parameter is a first scanning frequency of the first light source, the second lighting parameter is a second scanning frequency of the second light source, the first scanning frequency is synchronized with the second scanning frequency, and the first scanning frequency and the second scanning frequency has phase difference with a feature of light and dark complementary.

5. The illumination system of claim 4, wherein the phase difference between the first scanning frequency and the second scanning frequency is one hundred and eighty degrees, or the phase difference is one hundred and eighty degrees with an allowable error of ten percent.

6. The illumination system of claim 4, wherein a duration of a high level area of at least one of the first scanning frequency and the second scanning frequency is greater than a duration of a low level area of the at least one of the first scanning frequency and the second scanning frequency.

7. The illumination system of claim 1, wherein the first lighting parameter is a first scanning frequency of the first light source, the second lighting parameter is a second scanning frequency of the second light source, the first scanning frequency is different from the second scanning frequency, and the first scanning frequency and the second scanning frequency has phase difference with a feature of light and dark complementary.

8. The illumination system of claim 1, wherein the first lighting parameter is a first scanning frequency of the first light source, the second lighting parameter is a second scanning frequency of the second light source, and a first scanning direction of the first scanning frequency is different from a second scanning direction of the second scanning frequency.

9. The illumination system of claim 8, wherein the first scanning direction is opposite to the second scanning direction.

10. The illumination system of claim 1, wherein the first light source and the second light source respectively are a light emitting diode, the illumination system further comprises a micro-reflector adapted to reflect illumination light emitted by the foresaid light emitting diodes for adjusting the first lighting parameter and the second lighting parameter and further providing the first illumination range and the second illumination range.

11. The illumination system of claim 1, wherein the first light source and the second light source respectively are a LED module, and the LED module comprises a plurality of light emitting diode units arranged as an array.

12. The illumination system of claim 1, wherein the first light source and the second light source respectively are a laser unit, the illumination system further comprises a micro-reflector adapted to reflect illumination light emitted by the foresaid laser units for adjusting the first lighting parameter and the second lighting parameter and further providing the first illumination range and the second illumination range.

13. The illumination system of claim 1, wherein the illumination system further comprises an optical detector electrically connected to the operation processor, the operation processor is adapted to analyze an environment detection result of the optical detector for adjusting the first lighting parameter and/or the second lighting parameter.

14. The illumination system of claim 13, wherein the illumination system is applied to a headlight.
